(19) United States
(12) Patent Application Publication
(10) Pub. No.: US 2009/0139050 A1
(43) Pub. Date: Jun. 4, 2009

(54) DOOR STOP APPARATUS

(76) Inventor: Mitch Junkins, Newport Beach, CA (US)

Correspondence Address: Rutan & Tucker, LLP., 611 ANTON BLVD, SUITE 1400, COSTA MESA, CA, 92626, US

(21) Appl. No.: 12/326,007

(22) Filed: Dec. 1, 2008

Related U.S. Application Data
(60) Provisional application No. 60/991,657, filed on Nov. 30, 2007.

(51) Int. Cl. E05F 5/02; E05F 5/10

(52) U.S. Cl. 16/84; 16/82

(57) ABSTRACT

An improved door stop apparatus is provided. The improved door stop may have a brake mechanism having a brake portion and a brake release portion. Further, the brake mechanism may also have a magnetic portion that corresponds to a metal piece adhered to a wall for keeping the door ajar when friction and/or traction is not available. Additionally, an improved door stop apparatus is provided whereby the brake portion is adapted to a mounting plate that fits to a door wherein the brake mechanism may rotate about the mounting plate. Moreover, the present invention provides an improved door stop whereby the door stop is adaptable to be removably attached to any door without the need for permanent affixment of the door stop to the door.

### PRIORITY CLAIM

This application claims priority to the earlier filed U.S. Provisional Patent Application 60/991,657, filed on Nov. 30, 2007 which is hereby incorporated herein by reference in its entirety.

### FIELD OF THE INVENTION

The field of the invention is for a device to hold a door in a fixed location. More specifically, the field of the invention is for an adaptable door stop apparatus for holding a door open when in use.

### BACKGROUND

Doorstops are devices that hold a door open, or prevent the door from opening when desired by a user. Since the advent of doors that open and close, there has been a need for a device, object or apparatus that can hold the door open, especially when the door contains some type of hydraulic and/or pneumatic door opener, and/or closer. In most prior art doors, a hydraulic arm is utilized to close the door after entry of an individual into a room, thereby allowing for hands free closing of the door after the individual has utilized the door. The problem with these types of hydraulic arms that close after each use, is that they can be problematic when an individual needs to re-enter a room multiple times. Moreover, they may be much more difficult to open because of the added pressure that it requires to open the door in the first place.

Today, many different devices have been utilized to hold a door open when desired by an individual. The most simple application is the use of a heavy solid object that is placed in the pathway of the door thereby precluding the door from closing. The object is to put more pressure on the door than the door exerts on its own, thereby allowing the individual to freely cross through the door without the need to continually open the door. However, one problem with such a device is that they take up considerable room and can be easily moved out of place and thereby not have the desired effect. For example, if a brick is placed in front of the door to keep it open, it is possible that the brick may be improperly dislodged and thereby allow the door to close. Additionally, it is entirely foreseeable that an individual may trip on the brick if it is in the path of a walkway or if the individual does not see the device because they are carrying an article or other items that may block their view of the pathway. In this scenario, the problem is that the object may create a more hazardous situation than it's worth.

Another contemplated prior art door stop is the wedge. In this embodiment, a wedge may consist of different materials that may be utilized whereby friction between the floor and the bottom portion of the door is used to keep the door open. However, if the floor is a smooth surface, the wedge may not have needed the traction to provide the necessary function. Therefore, often times, the wedge does not stay in place and the door is allowed to close.

Another contemplated embodiment is the door stop. The door stop is typically a metal bar that is connected to the door via a hinge. At the bottom of the metal bar is a rubber padding that provides the necessary traction and frictional force to keep the door from closing. However, one problem with this door stop is that if the rubber padding becomes dirty, it loses its ability to maintain traction and thereby the friction will allow the door to close even when it is being utilized properly. Additional problems with this type of door stop is the need for permanent attachment to the door. Most times, the hinge is drilled into the door itself and is connected permanently to the hinge. Additionally, when a user desires to release the door stop and allow the door to close, typically it takes sufficient tactile force in order to remove the door stop from its utilized position and allow the door to close.

Therefore, a need exists for an improved door stop apparatus that may be utilized to keep a door from closing. Additionally, a need exists for an improved door stop apparatus that may be removably attached to a door and can be easily engaged and disengaged by the user without the need for excessive tactile force. Moreover, a need exists for an improved door stop apparatus having a brake and a brake relate and an attachment means for attaching to any door without the need for permanent placement of the door stop apparatus thereon.

### SUMMARY OF THE INVENTION

The present invention provides an improved door stop apparatus having a brake portion and a brake release portion. Additionally, the present invention provides an improved door stop apparatus having a brake portion adapted to fit a door wherein the brake portion may rotate to be adapted to a wall and/or other vertical surfaces. Moreover, the present invention provides an improved door stop whereby the door stop is adaptable to be removably attached to any door without the need for permanent affixment of the door stop to the door.

Among the many different possibilities contemplated, the apparatus may allow for multiple configurations of the apparatus whereby the door stop may be configured to adapt to a plurality of different doors when desired by a user.

To this end, in an exemplary embodiment of the present invention an apparatus for use as a door stop, the apparatus comprising: a brake assembly having a brake housing and at least a brake portion and a brake release portion; said brake portion having at least a padded surface therein; and a mounting bracket with an attachment portion for mounting the apparatus to a door.

In an exemplary embodiment, the apparatus wherein said apparatus is constructed of metal.

In an exemplary embodiment, the apparatus wherein said apparatus is constructed of plastic.

In an exemplary embodiment, the apparatus wherein said brake portion is hydraulically activated.

In an exemplary embodiment, the apparatus wherein said attachment portion has an adhesive portion to attach the mounting bracket to the door.

In an exemplary embodiment, the apparatus wherein the mounting bracket is attached to the brake mechanism.

In an exemplary embodiment, the apparatus wherein the brake mechanism is attached to the mounting bracket and further wherein the brake mechanism is rotatable about the mounting bracket.

In an exemplary embodiment, the apparatus wherein the brake portion has a rubber edge to provide traction and friction to keep a door ajar.

In an exemplary embodiment, the apparatus wherein the mounting bracket is removably attached to at least a bottom edge of a door.

In an exemplary embodiment, the apparatus wherein the brake release is manually manipulated to cause the brake portion to retract into a brake housing.

In an exemplary embodiment, the apparatus wherein the brake portion has a magnetic portion thereon.

In an exemplary embodiment, the apparatus further comprising: a brake release mechanism whereby the brake release mechanism allows for release of the brake.

In an exemplary embodiment, the apparatus wherein the mounting bracket is removably attached to the brake assembly housing.

In an exemplary embodiment, the apparatus wherein the mounting bracket is pivotally attached to the brake assembly housing Additionally, in an exemplary embodiment, the apparatus may be configured such that the door stop may be removably attached to any door.

In another exemplary embodiment, it is contemplated that the apparatus may have at least a brake portion.

In yet another exemplary embodiment, it is contemplated that the apparatus may have at least a brake portion and a brake release portion.

Still a further exemplary embodiment contemplates where the apparatus may have a brake release portion which may be manually manipulated by a user's foot.

In a further exemplary embodiment, it is contemplated that the apparatus is configured to be rotatable about the door attachment means.

A further exemplary embodiment contemplates that the apparatus may be constructed of a suitable material such as plastic.

In another exemplary embodiment, it is contemplated that the apparatus may be constructed of any suitable material such as metal, alloy and the like.

Further, a contemplated embodiment of the apparatus may be constructed of a suitable material such as rubber, foam, composite, plastic and the like whereby the device may be rigid enough to provide the function of a door stop.

Additionally, in an exemplary embodiment, the apparatus may have a door stop having a first side and a second side wherein the first side may have a hydraulic brake that extends downwardly toward a surface and may utilize friction and traction in order to maintain a door in the open position.

In yet another exemplary embodiment, it is contemplated that the apparatus may have a first side and a second side wherein the first side may be a hydraulic brake that extends downwardly and wherein the bottom edge of the first side is constructed of rubber that contacts the floor.

A further exemplary embodiment of the present invention may include an apparatus whereby the apparatus may have a mounting plate, whereby the mounting plate may mount to the bottom edge of a door and further wherein the mounting plate may surround at least a portion of the bottom edge of the front side of a door and the bottom edge of the back side of a door.

Still, another exemplary embodiment of the present invention may include an apparatus that may have a mounting plate whereby the mounting plate may have an adhesive portion on the inner surface thereon for attachment of the mounting plate to the bottom edge of the door.

A further exemplary embodiment of the present invention may include an apparatus wherein the apparatus may have a mounting plate wherein the mounting plate may be attached to the brake mechanism.

In yet another exemplary embodiment of the present invention, the apparatus may have a mounting plate thereon wherein the mounting plate is attached to the brake mechanism whereby the brake mechanism is rotatable about the mounting plate.

Yet another exemplary embodiment of the present invention may provide an apparatus whereby the apparatus may have a brake mechanism whereby the brake mechanism may have a magnetic portion thereon for attachment to a metal piece adhered to a wall.

In an exemplary embodiment of the present invention, an apparatus may be provided whereby the apparatus may have a brake mechanism whereby the mechanism may have a brake release portion, a hydraulic brake, a magnetic portion and may be rotatable about the attached mounting plate.

Another exemplary embodiment of the present invention may include an apparatus that may be adapted for use with a plurality of differently sized, and dimensioned doors.

In yet another exemplary embodiment of the present invention, an apparatus is provided whereby the apparatus requires a minimal tool used to assemble, and/or utilize, and may be easily removed from a door and placed on another door when desired by a user.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective view of the invention illustrating the apparatus in an exemplary embodiment of the present invention;

FIG. 2 is another perspective view of the invention in an exemplary embodiment of the present invention;

FIG. 3 is a perspective view of the invention whereby the door stop assembly is attached to a door; and

FIG. 4 is another perspective view of the invention is an exemplary embodiment of the present invention.

### DETAILED DESCRIPTION OF THE INVENTION

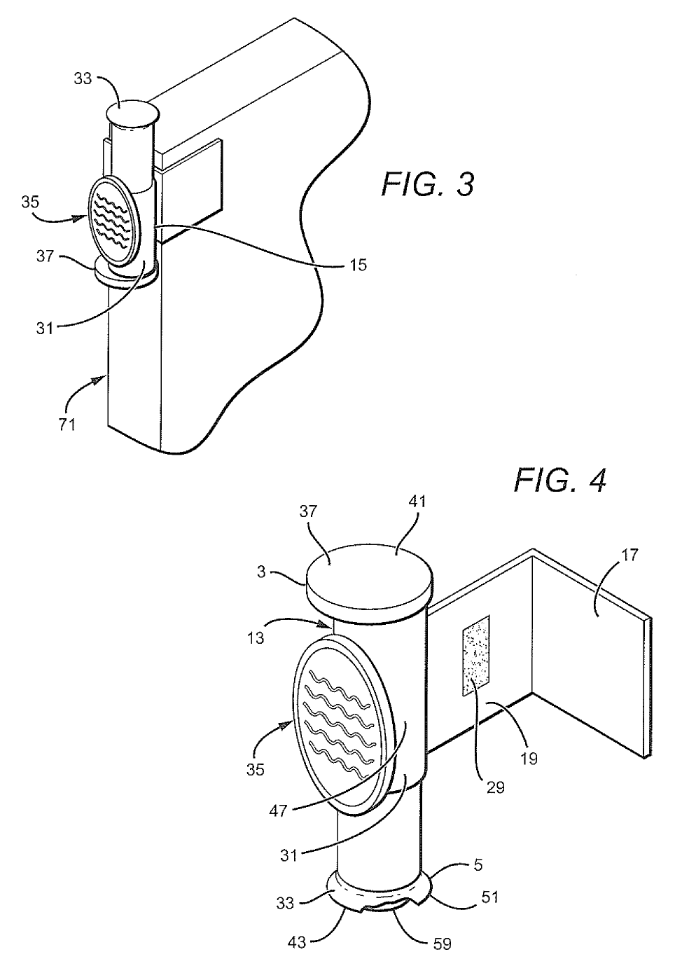

Referring now to the drawings were like numbers are referenced to describe the invention, a door stop apparatus 1 is illustrated. The door stop apparatus 1 has at least a top portion 3 and a bottom portion 5. The top portion 3 may be oriented such that the top portion is viewable by a user from their vantage point. In an exemplary embodiment the door stop apparatus 1 may be adapted to fit about the bottom portion of a door (see element 71 in FIG. 3). However it should be understood that the door stop apparatus 1 may be utilized on any portion of the door 71 which it may be adapted thereto. In an exemplary embodiment, the door stop apparatus 1 may have a mounting bracket 11 attached to a brake assembly 13. The mounting bracket 11 may have a first side 15 and a second side 17 whereby the first side 15 is adapted to be in close association with the brake assembly 13. Moreover, the first side 15 may be pivotally attached to the brake assembly 13 and may rotate about the brake assembly 13 when desired by the individual user. This concept will be explained in further detail below.

The second side 17 is attached to the first side IS by an attachment portion 19. The attachment portion 19 may span the distance between the first side 15 and the second side 17. In an exemplary embodiment, the space between the first side 15 and the second side 17 may be the slightly larger than the approximate distance of the width of a common door. Thereby the width of the door would fit between the first side 15 and the second side 17 and in a preferred embodiment may be adapted for fitment into the attachment portion 19 of the mounting bracket 11. The mounting bracket may be rotatably attached to the brake assembly 13 as illustrated in FIG. 2.

The mounting bracket 11 further includes the attachment portion 19 which extends away from the brake assembly 13. The mounting bracket includes the first side 15 which is in pivotal relation with the brake assembly and which extends vertically down to a attachment portion which extends horizontally away from the brake assembly 13. The attachment portion 19 has a first end 21 and a second end 23. The first end 21 is in communication with the first side 15 of the mounting bracket 11, while the second end 23 is in communication with the second side 17 of the mounting bracket 11. The second side 17 extends vertically away from the second end 23 of the attachment portion 19. The net effect of the attachment portion 19 is that is encompasses an indentation effect allowing for insertion of a portion of a door to be inserted into the space provided by the attachment portion 19 relationship to the first 15 and second 17 sides of the mounting bracket 11.

In an exemplary embodiment, the attachment portion 19 may have a connection means 27 to connect the attachment portion 19 to the door to which is will be attached. In an exemplary embodiment, the connection means 27 may be an adhesive tape 29. However, it is contemplated that any of a plurality of connection means 27 may be provided such as hook and fastener, screws, nails, snap fit, and the like may also be provided to attach the attachment portion 19 of the mounting bracket 11 to a door portion. It should also be understood that the attachment portion 19 may be affixed to a door, but may also be removed and affixed to another portion of the door when desired by the individual, and/or may be removed from one door and attached to other subsequent doors when desired.

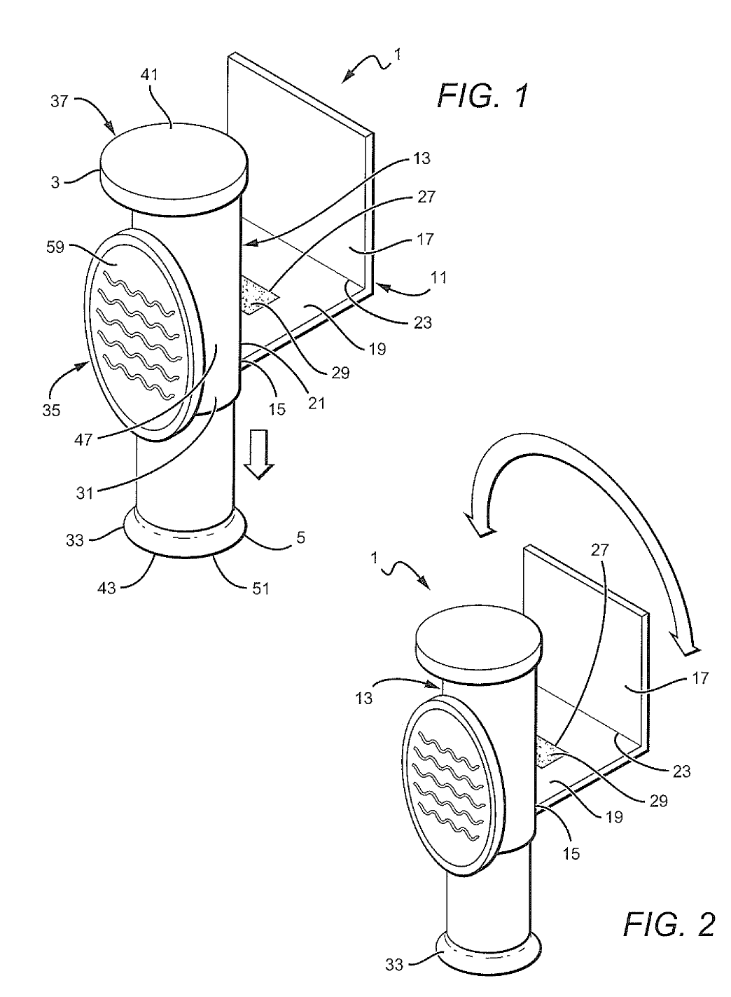

FIG. 1 further illustrates the brake assembly 13. The brake assembly has a generally cylindrical housing 31 which may accommodate the brake 33, the brake release mechanism 35 and the brake application assembly 37. The housing may contain hydraulic fluid which allows for setting and application of the brake application assembly 37 and the brake 33. In an exemplary embodiment, the brake application assembly 37 is located at the top portion 41 of the housing 31 whereby the brake 33 is located on the bottom portion 43 of the housing. The brake release mechanism 35 in an exemplary embodiment may be located on the side 47 of the housing 31 whereby it may be activated by the user more easily. In operation, the user would utilize the brake application assembly 37 by pressing down onto it, which would hydraulically activate the brake 33 to extend away from the housing 31 and frictionally attached to a generally planar surface, such as a floor. The brake 33 may have a rubber padding surface 51 which may aid in frictionally attaching to the generally planar surface, such as a floor. The rubber padding surface 51 may be replaced with other materials that may aid in the frictional attachment and stopping of the door assembly apparatus 1. For example, the padding surface 51 may be comprised of felt, rubber, wood, metal or any other material that would allow for better frictional forces between the brake 33 and the generally planar surface to which is will be frictionally attached. It should be contemplated that the padding surface 51 may be replaceable by any of the contemplated types of material to accommodate better frictional relationship between the brake and the generally planar surface, such as a floor etc. In another exemplary embodiment, it is contemplated that a magnetic padding may be provided to the bottom of the brake 33 whereby when the brake 33 comes in contact with a metallic surface, the padding surface 51 may be comprised of a magnetic which may be strong enough to hold the entire door assembly 1 and attached door 1 from moving. Moreover, it is contemplated that the brake release mechanism 35 may also have a magnetic portion thereon such that is may add to the magnetic attachment to a surface when desired by the individual user.

In operation, the user may utilize the brake application assembly 37, by pushing it in, thereby hydraulically activating the brake 33 to be in frictional relation to a surface. It should be understood that as further anticipated, the brake assembly apparatus 37 may be in contact with a generally flat surface such as a floor, but may also be rotated 180 degrees such that the brake assembly 37 may also be in fluid contact with a ceiling. Thereby the door stop assembly 1 may be utilized on both a top portion of a door and a bottom portion of a door 71. When the brake application assembly 37 is engaged, the brake 33 along with the padding surface 51 will extend out of the housing until the padding surface 51 frictionally contacts a surface at which point the brake 33 stops from extending further from the housing. Because of the frictional forces, the brake causes the door stop apparatus 1 to stop the door from moving from the position it is in relative to the door stop apparatus 1.

When the user desires to move the door after application of the brake 33, the user simply activates the brake release mechanism 35 which is located on the side portion 47 of the housing 31. When applied, the brake release mechanism 35 causes the brake 33 to move back into the housing 31 and removes the frictional forces of the padding 51 from the generally planar surface, thereby allowing the door which is attached to the attachment portion 19 of the mounting bracket 11 to move freely.

As illustrated in FIGS. 2 and 4, the brake housing 31 may rotate 180 degrees from the mounting bracket 31. This would allow the brake housing 31 to face another generally planar surface, such as a ceiling instead of a floor. This may be advantageous such that the brake housing 31 is removed from the footpath of an individual that is utilizing the door stop apparatus 1. However, it is also contemplated that the brake housing 31 may be rotated and locked into any position therebetween such that the brake 33 and the associated padding surface 51 may be utilized on a side surface such as a wall. In an exemplary embodiment, the brake release mechanism 35 may be provided with a frictional padding element, thereby allow it to also be utilized to frictional stop a door from moving. Moreover, both the brake release mechanism 35 and the brake 33 may have magnetic portions 59 which may allow them to attached to a corresponding metal portion of a wall, floor, ceiling or the like. In an exemplary embodiment, a corresponding metal portion may be temporarily adapted to a portion of a wall to allow for the door stop apparatus to have a magnetic attachment to that metal apparatus when a surface isn't planar enough to provide frictional stopping power.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

Thus, specific embodiments and applications of modular overhead storage have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C, . . . and N, the text should be interpreted as requiring only one element from the group, not A plus N, or B plus N, etc.

I claim:

1. An apparatus for use as a door stop, the apparatus comprising:
a brake assembly having a brake housing and at least a brake portion and a brake release portion;
said brake portion having at least a padded surface therein; and
a mounting bracket with an attachment portion for mounting the apparatus to a door.

2. The apparatus described in claim 1 wherein said apparatus is constructed of metal.

3. The apparatus described in claim 1 wherein said apparatus is constructed of plastic.

4. The apparatus described in claim 1 wherein said brake portion is hydraulically activated.

5. The apparatus described in claim 1 wherein said attachment portion has an adhesive portion to attach the mounting bracket to the door.

6. The apparatus described in claim 1 wherein the mounting bracket is attached to the brake mechanism.

7. The apparatus described in claim 1 wherein the brake mechanism is attached to the mounting bracket and further wherein the brake mechanism is rotatable about the mounting bracket.

8. The apparatus described in claim 1 wherein the brake portion has a rubber edge to provide traction and friction to keep a door ajar.

9. The apparatus described in claim 1 wherein the mounting bracket is removably attached to at least a bottom edge of a door.

10. The apparatus described in claim 1 wherein the brake release is manually manipulated to cause the brake portion to retract into a brake housing.

11. The apparatus described in claim 1 wherein the brake portion has a magnetic portion thereon.

12. The apparatus described in claim 1 further comprising:
a brake release mechanism whereby the brake release mechanism allows for release of the brake.

13. The apparatus described in claim 1 wherein the mounting bracket is removably attached to the brake assembly housing.

14. The apparatus described in claim 1 wherein the mounting bracket is pivotally attached to the brake assembly housing.
